(19) United States
(12) Patent Application Publication
(10) Pub. No.: US 2018/0216989 A1
(43) Pub. Date: Aug. 2, 2018

(54) Tamper Resistant Adherable Weight Scale

(71) Applicant: Oscar Servin, Englewood, CO (US)

(72) Inventor: Oscar Servin, Englewood, CO (US)

(21) Appl. No.: 15/797,914

(22) Filed: Oct. 30, 2017

Related U.S. Application Data
(60) Provisional application No. 62/451,476, filed on Jan. 27, 2017.

(51) Int. Cl. G01G 21/23; G01G 23/36; G08B 21/18

(52) U.S. Cl. CPC G01G 21/23; H04L 67/12; G08B 21/18; G01G 23/36

(57) ABSTRACT

A tamper-resistant adherable weight scale is described herein. The adherable weight scale generally includes one or more load sensors, a microcontroller, a display panel, and an adhesive material to adhere a sensing surface of the load sensor, either directly or indirectly, to a bottom surface of an object such that the load sensor can continuously monitor a sensed load of the object when adhered thereto. The microcontroller may further include a processor and memory to log and store the sensed loads or weight measurements in the memory. The adherable weight scale is io particularly advantageous for the continuous monitoring and/or logging the weight of a regulated substance that is added or removed from a container adhered to the adherable weight scale.

### CROSS-REFERENCE TO RELATED APPLICATIONS

This application claims priority to U.S. Provisional Patent Application Ser. No. 62/451,476 filed Jan. 27, 2017; the contents of which are hereby incorporated by reference.

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

Various types of weight scales, particularly digital weight scales, are generally known in the art. For example, a digital weight scale may include a load sensor for converting a mechanical load into an electrical signal, a processor for converting the signal into a displayable weight measurement, and a display panel for displaying the weight measurement; all of which are assembled to allow a user to weigh a variety of different objects. However, most weight scales are stationary, in that a user typically moves or transports the object to be weighed to the location of the scale and records a measurement, rather than moving the scale to the object. This manual task of transporting the object to the scale and recording the object's weight may be repetitive and time-consuming for objects that require several weight measurements over a given time period. For instance, the Federal Food and Drug Administration (FDA) or other regulatory agency, in the wake of the United States opioid epidemic, may start requiring drug manufacturers and pharmacies to perform several weight measurements of prescription drug containers throughout a day, week, year, or the product lifetime as a method to track, log, or account for the prescription drugs that are added or removed from the container. Having to perform and record these several weight measurements manually is quite time consuming. In addition, the FDA or other regulatory agency may request semi-yearly reports of the weight measurements from the manufacturers or pharmacies, to ensure the manufacturers and/or pharmacies are reporting correct numbers. The FDA would therefore likely need to audit the manufacturer and/or pharmacy, which may increase the overall cost to produce and sell the prescription drugs. Finally, there is a possibility that the containers and weight measurements may be tampered-with to skew the reported numbers. In which case, even in the course of an audit, the actual amount of drugs dispensed may incorrectly agree with the reported numbers.

Therefore, there is a need for a tamper-resistant scale designed to stick or adhere to an object, display or log the object's weight, and monitor if the scale or object adhered thereto has been tamper-with.

### FIELD OF THE INVENTION

The present invention generally relates to scales, and more particularly, to a weight scale that is adherable to a surface of an object to remain attached thereto and constantly read, log, and/or monitor the weight of the object.

### SUMMARY OF THE INVENTION

The general purpose of the adherable weight scale, described subsequently in greater detail, is to provide an adherable weight scale which has many novel features that result in a adherable weight scale which is not anticipated, rendered obvious, suggested, or even implied by prior art, either alone or in combination thereof.

An adherable weight scale is provided to continuously monitor the weight of an object when adhered thereto. The adherable weight scale includes a load sensor having a sensing surface for sensing loads imposed on the sensing surface. A microcontroller is in communication with the load sensor to convert a sensed load into a displayable weight measurement. A display panel is in communication with the microcontroller to display the displayable weight measurement. A power source is connected to at least one of the load sensor, microcontroller, and the display panel to provide power thereto. And an adhesive material is adapted to removably adhere the sensing surface of the load sensor to a bottom surface of an object, either directly or indirectly, wherein the load sensor continuously senses a load of the object when adhered thereto.

The microcontroller may further include memory in communication with the processor. A software module stored in the memory comprising executable instructions that when executed by the processor cause the processor to: execute a first protocol when the object is first adhered to the load sensor, said first protocol executed in response to at least one of: i. a load sensed by the load sensor above a threshold load; ii. a tare function initiated to tare the load of the object; or iii. an activation of a mechanical trigger caused by the adherence of the object to the load sensor. The first protocol includes a set of first protocol executable instructions that when executed by the processor cause the processor to continuously monitor the presence of the object on the load sensor and log the sensed loads in the memory.

The software module may further include executable instructions that when executed by the processor cause the processor to: execute a second protocol to alarm the user if the object has been tampered-with or the adherable weight scale is malfunctioning, said second protocol executed in response to at least one of: a. a measured weight that is less than an initial weight of the object; b. a measured weight that is negative if the initial weight of the object was tared to zero; or c. a deactivation of the mechanical trigger caused by a dis-adherence of the object from the load sensor. The second protocol includes a set of second protocol executable instructions that when executed by the processor cause the processor to initiate an alarm to warn the user that the adherable weight scale is malfunctioning, the object has been tampered-with, or the object has been removed from the load sensor.

The adherable weight scale may further include a transceiver in communication with both the processor and a network. The transceiver may transmit at least one of the sensed load, weight measurement, or alarm across the network to at least one of an end-user or external database to continuously monitor the weight of an object from an external location away from the adherable weight scale.

An internal network of adherable weight scales is also provided. The internal network of adherable weight scales includes a plurality of adherable weight scales of for adhering to multiple regions of a bottom surface of an object. The network includes a router in communication with the plurality of adherable weight scales to send and receive data to and from the plurality of adherable weight scales and a server in communication with the router to receive and store data accessible by one or more user devices. The one or more user devices may be a personal computer, a tablet, a smartphone, or other peripheral devices. The plurality of adherable weight scales may each include a wireless transceiver to wirelessly transfer data to and from the router. The server may further include inventory management control software for managing an inventory of a substance added or removed from the object.

Thus has been broadly outlined the more important features of the present adherable weight scale so that the detailed description thereof that follows may be better understood and in order that the present contribution to the art may be better appreciated.

Objects of the present adherable weight scale, along with various novel features that characterize the invention are particularly pointed out in the claims forming a part of this disclosure. For better understanding of the adherable weight scale, its operating advantages and specific objects attained by its uses, refer to the accompanying drawings and description.

### BRIEF DESCRIPTION OF THE DRAWINGS

### Figures

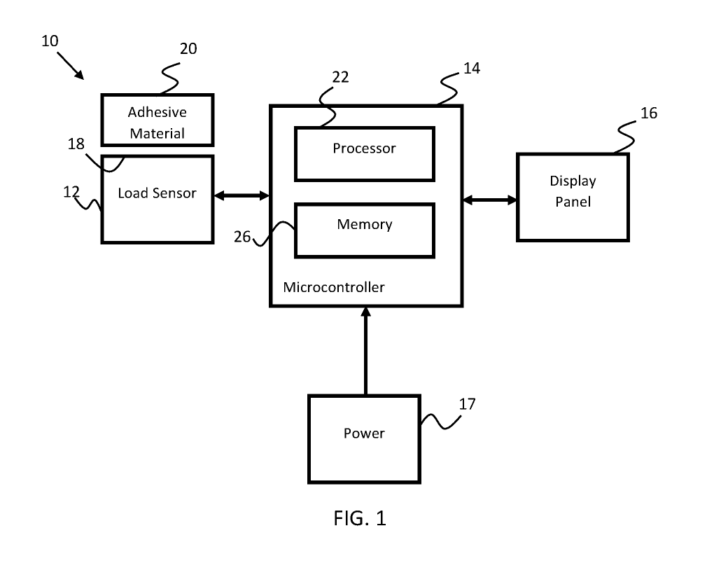

FIG. 1 is a diagram of the general components of an adherable weight scale.

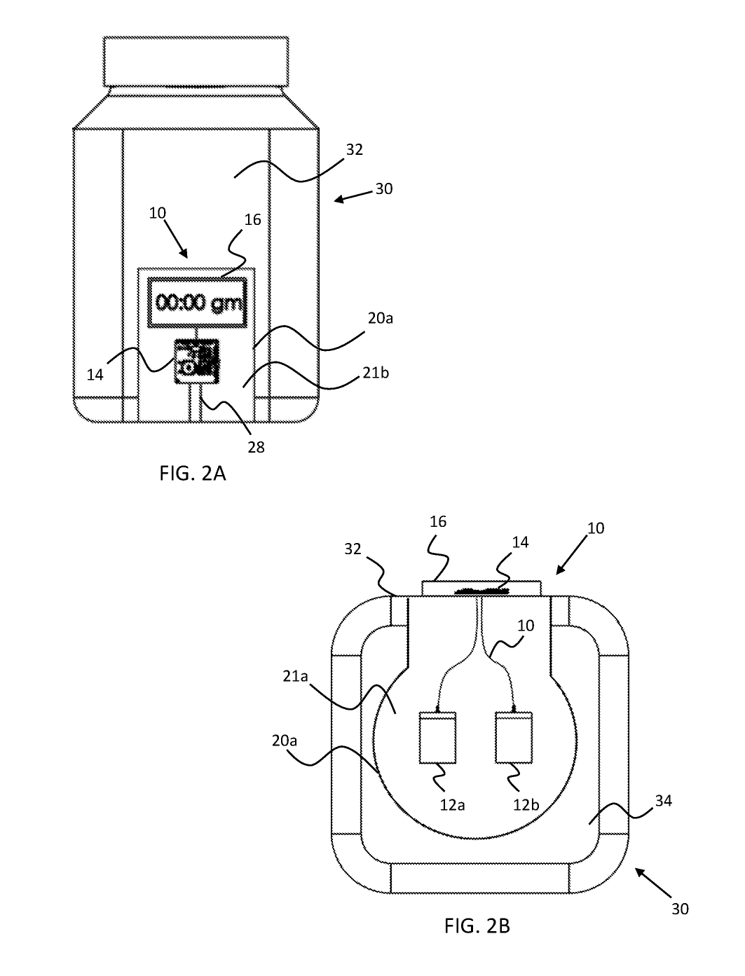

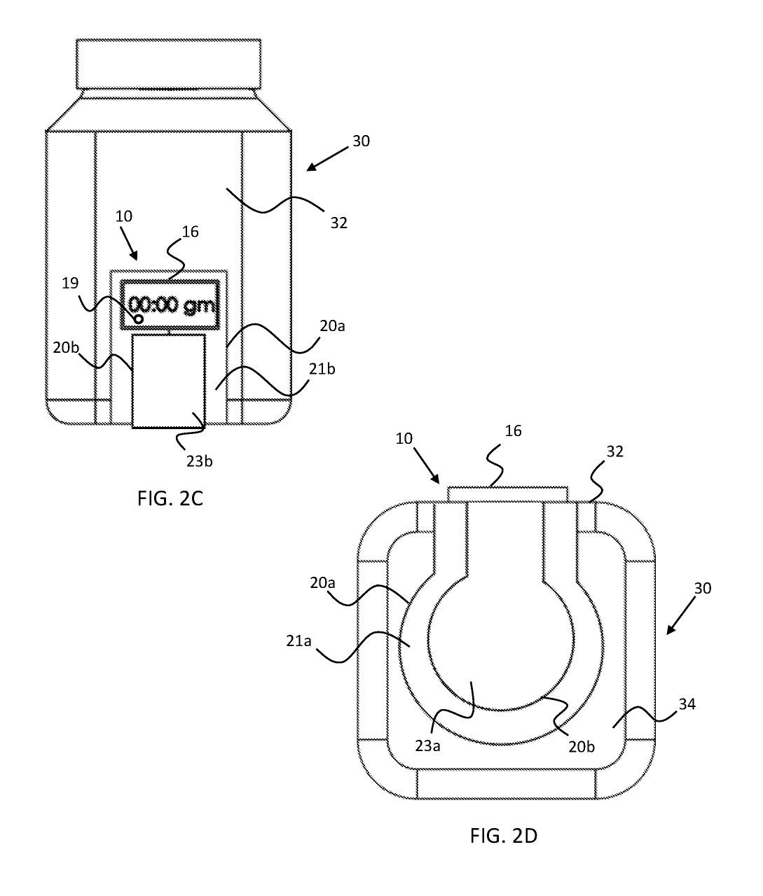

FIGS. 2A-2D depict an adherable weight scale adhered to an object, where FIG. 2A is a front view thereof, FIG. 2B is a bottom view thereof, FIG. 2C is second front view thereof, and FIG. 2D is a second bottom view thereof.

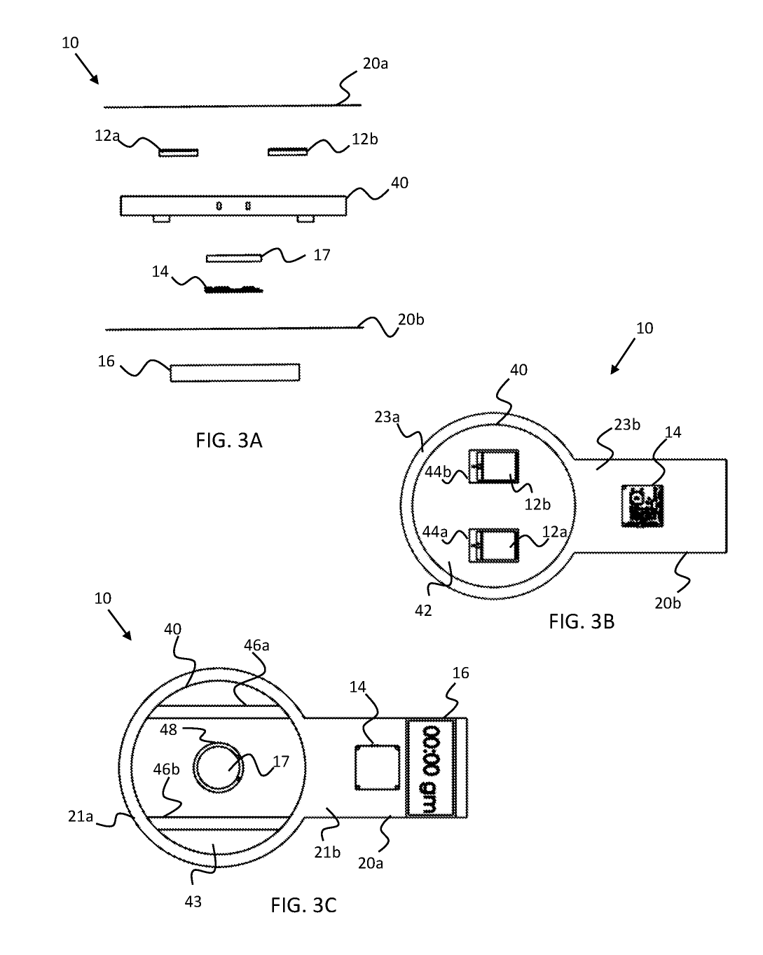

FIGS. 3A-3C depict an adherable weight scale having a tray, where FIG. 3A is a front exploded view thereof, FIG. 3B is an assembled top view thereof, and FIG. 3C is an assembled bottom view thereof.

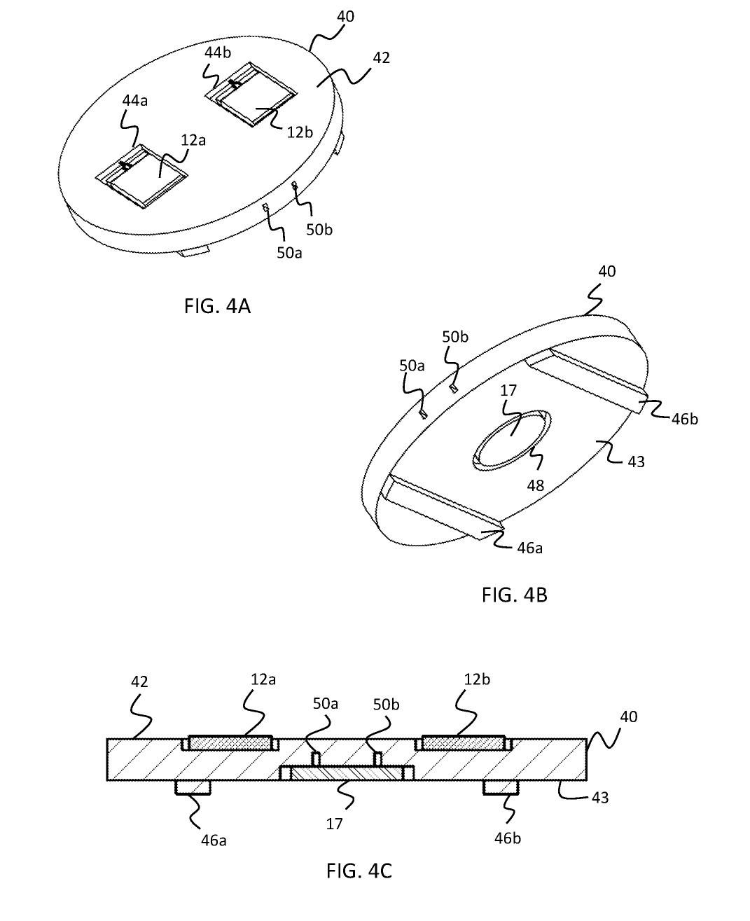

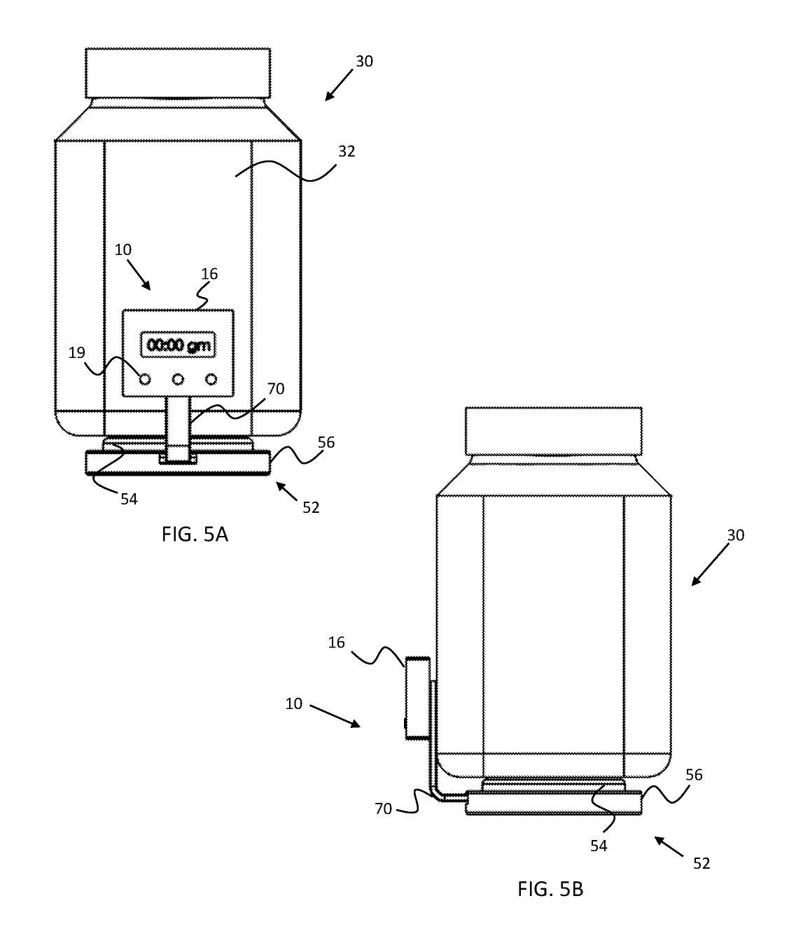

FIGS. 4A-4C depict the tray of FIGS. 3A-3C in more detail, where FIG. 4A is a top perspective view thereof, FIG. 4B is bottom perspective view thereof, and FIG. 4C is a cross-sectional view thereof.

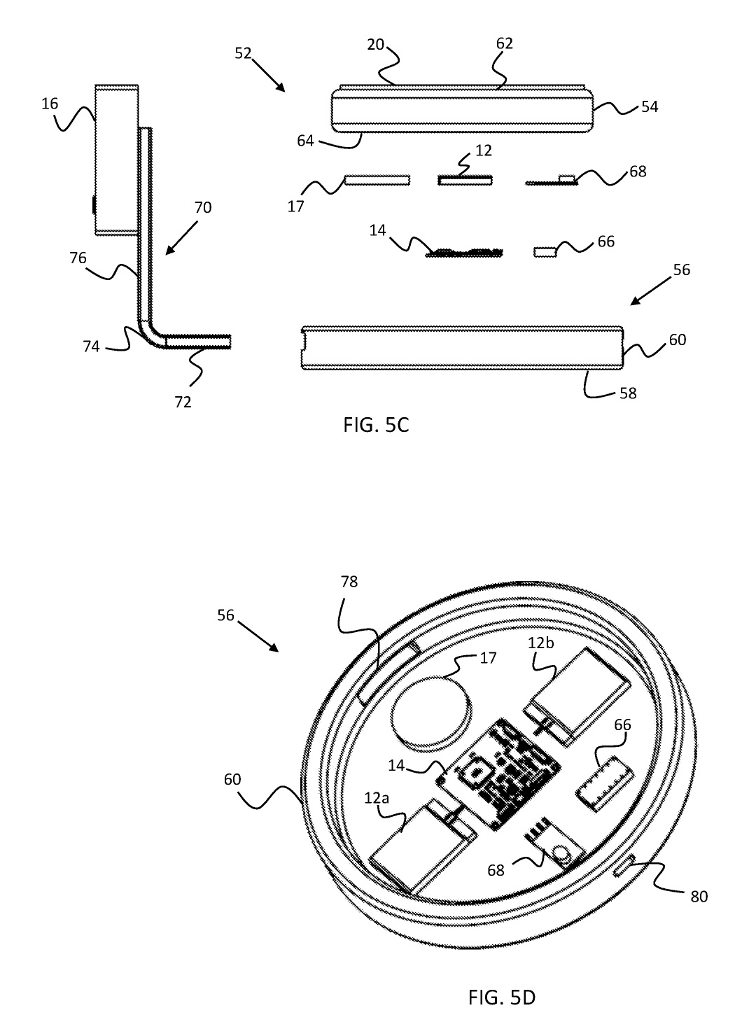

FIGS. 5A-5D depicts an adherable weight scale having a housing assembly, where FIG. 5A depicts a front view of the scale adhered to an object, FIG. 5B depicts a side view thereof, FIG. 5C depicts a side exploded view of the scale, and FIG. 5D depicts a top perspective view of the housing assembly.

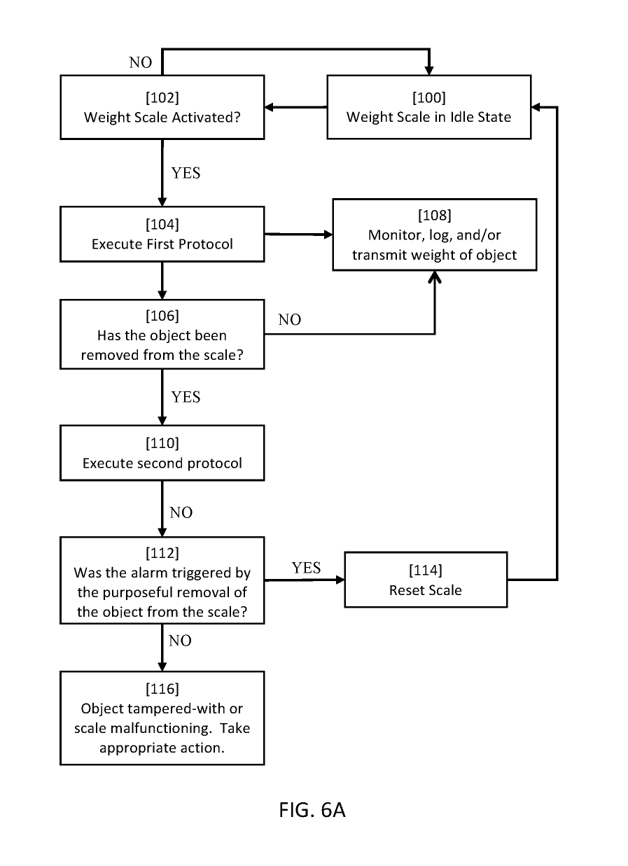

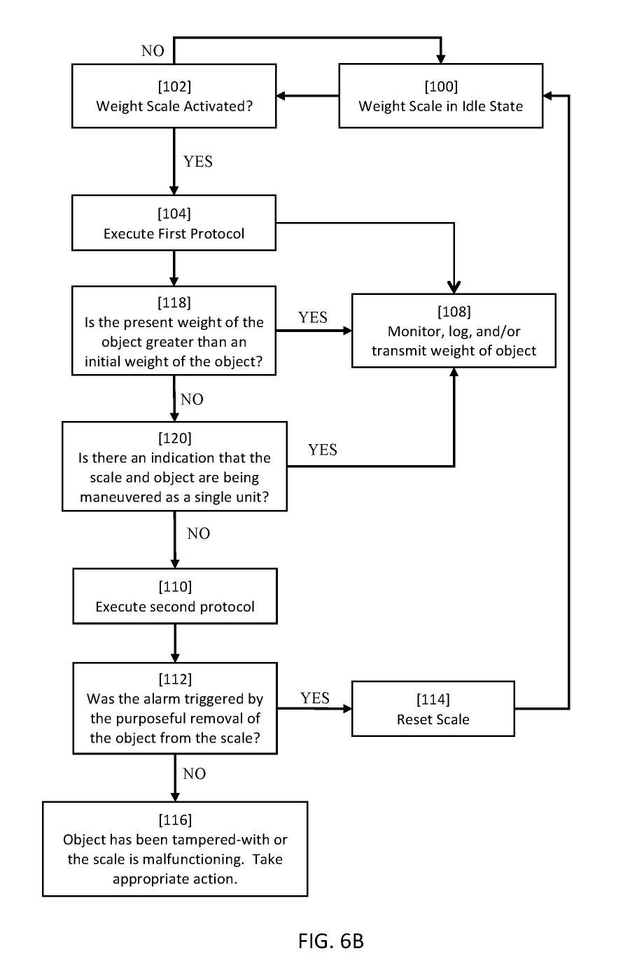

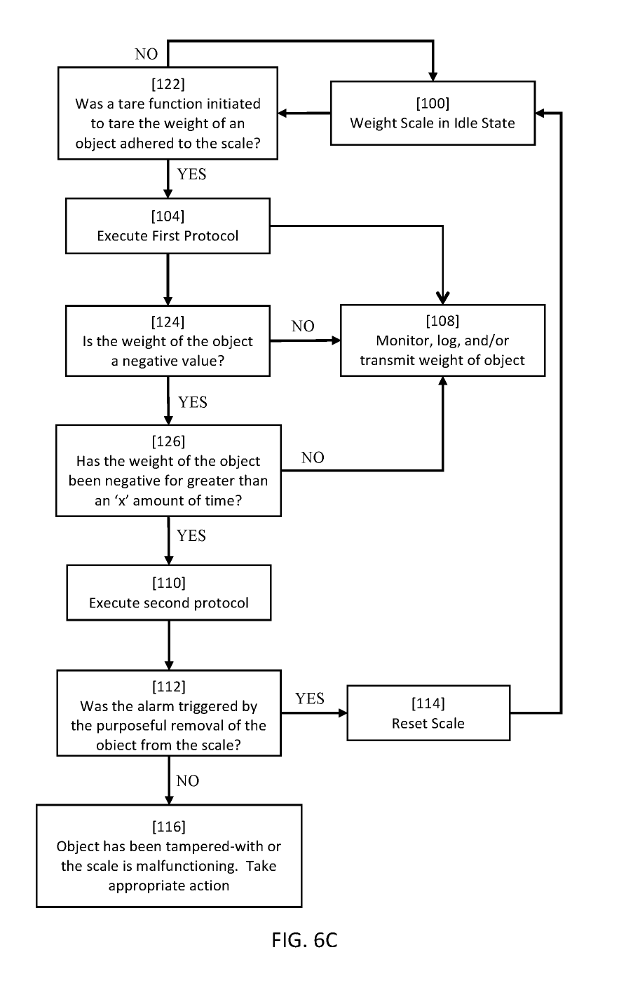

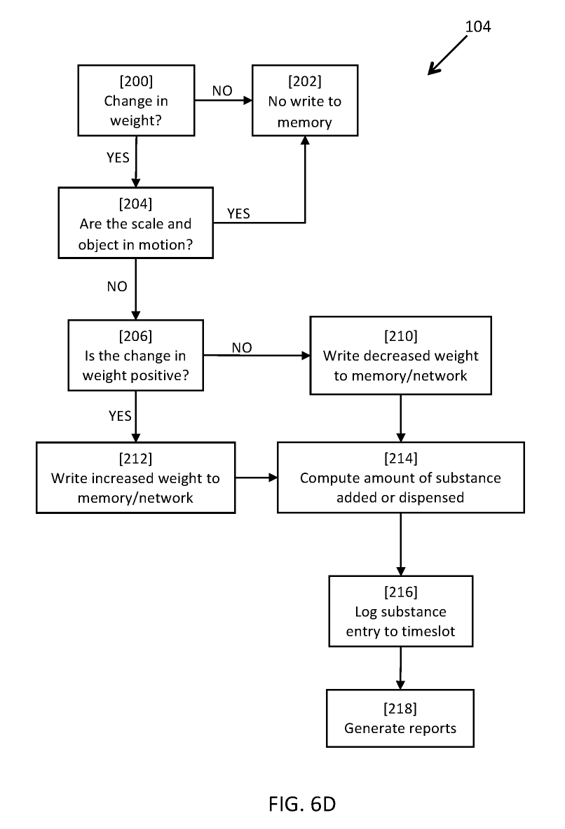

FIGS. 6A-6D depict flowcharts for using the adherable weight scale, where FIG. 6A is a general method for using the scale, FIG. 6B is a more detailed method for using the scale, FIG. 6C is another detailed method for using the scale, and FIG. 6D is a method for recording weights with the adherable weight scale.

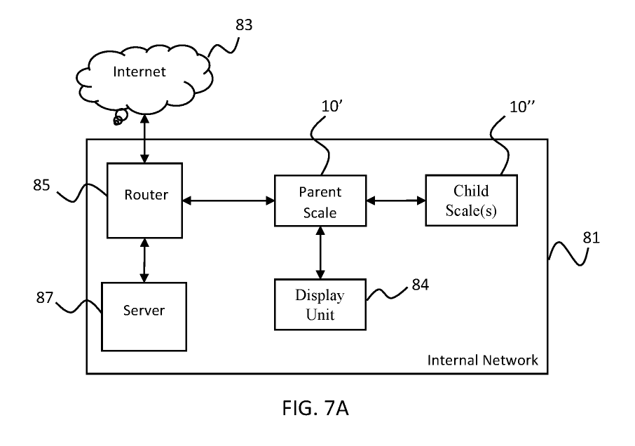

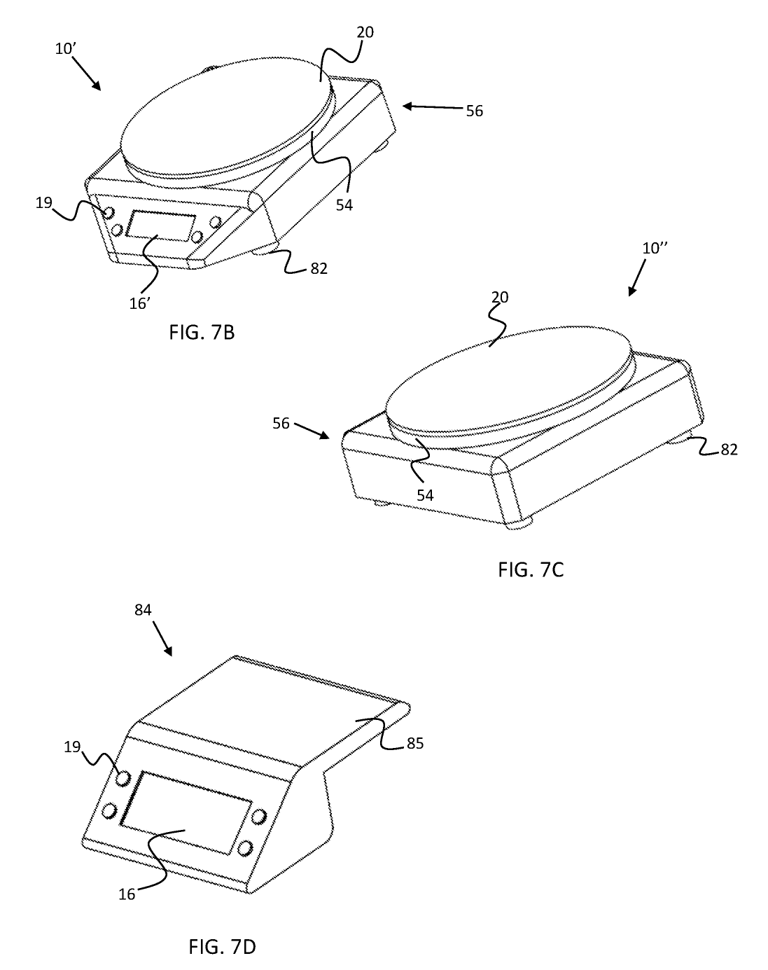

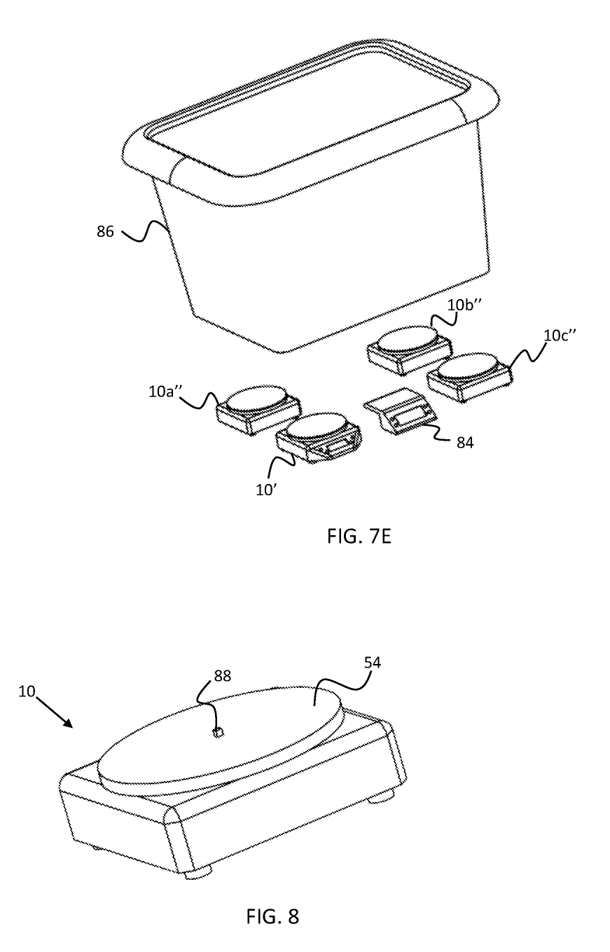

FIGS. 7A-7E depict an internal network of adherable weight scales, where FIG. 7A depicts the general components of the internal network, FIG. 7B depicts a parent weight scale, FIG. 7C depicts a child weight scale, FIG. 7D depicts a display unit, and FIG. 7E depicts an arrangement of a parent scale, three child scales, and a display unit.

FIG. 8 depicts an adherable weight scale having a mechanical trigger.

### DETAILED DESCRIPTION

The present invention has utility as an adherable weight scale to continuously weigh, monitor and/or log the weight of an object adhered thereto. The adherable weight scale is particularly advantageous for adhering to a container having a regulated product disposed therein such that the weight scale may continuously monitor an amount of the regulated product overtime. The following description of various embodiments of the invention is not intended to limit the invention to those specific embodiments, but rather to enable any person skilled in the art to make and use this invention through exemplary aspects thereof. It will be clear and apparent to one skilled in the art that the invention can be adapted for any of several applications illustratively including the continuous weighing, monitoring the weight, or logging the weight of a container having a substance disposed therein such as medications (e.g., opiates, antibiotics, marijuana), tobacco, alcohol (e.g., beer, wine, liquor), currency (e.g. quarters, dimes, nickels), or any other substance that is regularly added or removed from the container. Other potential applications may include the continuous weighing of an object disposed in a container, or an object itself, that is designed to degrade over-time to monitor and determine degradation rates of the object.

With reference now to the drawings, and in particular FIGS. 1 through 5D thereof, exemplary embodiments of the instant adherable weight scale employing the principles and concepts of the present adherable weight scale and generally designated by the reference number 10 will be described.

With reference to FIG. 1, a specific inventive embodiment of the general components of the adherable weight scale 10 is illustrated. The adherable weight scale 10 is configured to removably adhere to an object to continuously monitor and/or log the weight of the object when adhered thereto. As used herein, the term “removably adhere” refers to the adherence of an object to one or more portions of the adherable weight scale 10 and to stay adhered, unless the user desires to remove the object or the object is unintentionally removed (i.e., tampered-with). The adherable weight scale 10 may include a load sensor 12, a microcontroller 14 (e.g., master chip), a display panel 16, a power source 17, and an adhesive material 20. The load sensor 12 includes at least one sensing surface 18, where the load sensor 12 can sense or measure a load imposed on the sensing surface 18. The microcontroller 14 includes a processor 22 and is in communication with the load sensor 12 to convert a sensed load into a displayable weight measurement. The display panel 16 is in communication with the microcontroller 14 to display the displayable weight measurement. The microcontroller 14 may further include memory 26 (e.g., non-volatile or volatile) having instructions stored therein to be executed by the processor. The power source 17 is operatively connected to at least one of the load sensor, microcontroller, and the display panel to provide power thereto. The adhesive material 24 is adapted to removably adhere the sensing surface 18 of the load sensor 12 to a bottom surface of an object, either directly or indirectly, wherein the load sensor 12 can continuously sense a load of the object when adhered thereto. The terms, ‘direct’ and ‘indirect’ when referenced with respect to adherence, refers to a direct adherence (i.e., direct contact) of the sensing surface 18 to the object, or an indirect adherence (i.e., indirect contact) of the sensing surface 18 to the object by way of an intermediary structure positioned between the sensing surface 18 and the object, both scenarios of which are illustrated in embodiments below. Further, the term “in communication” refers to a wired or wireless connection between two or more stated elements (e.g., microcontroller 14 and load sensor 12), and does not necessarily require a direct one-to-one connection where other elements (e.g., circuitry, a network) may facilitate or be part of the connection between the two or more stated elements. The wired or wireless connection may be accomplished by means well known in the art such as Bluetooth, Wi-Fi, radiofrequency, and the like.

The load sensor 12 may be any suitable sensor configured to sense a load and calibrate an initial weight of an object, illustratively including a strain gauge load cell, a piezoelectric load cell, and a capacitive load cell. In a particular embodiment of the adherable weight scale 10, two or more load sensors, such as two 10 kg load sensors, are present to increase the measurement area, or one load sensor may act as a redundant sensor to either improve the accuracy of weight measurements or detect if the first load sensor or second load sensor is malfunctioning. However, other numbers and types of load sensors 12 are envisioned.

The display panel 16 may comprise any display panel suitable for displaying a weight measurement in the desired units (grams, ounces, pounds, etc.). In a particular embodiment, the display panel 16 includes a liquid crystal display (LCD) or light emitting diode (LED) display. The display panel 16 may further include one or more user input mechanism 19 (e.g., buttons) to communicate with the microcontroller 14.

The microcontroller 14 having a processor 22 and memory 26, may be any known in the art that is capable of executing instructions, and reading or providing input and/or output data to/from the load sensor 12, display panel 16, and any other peripheral devices (e.g., user input buttons, transceivers).

The power source 17 for the adherable weight scale 10 may be any power source 17 suitable to provide power to the load sensor 12, the microcontroller 14, the display panel 16, or a combination thereof and may illustratively include batteries, a hard A/C power connection from a wall outlet, and/or solar power strips or panels. In a particular embodiment, the power source 17 is a re-chargeable battery, such as a 3V lithium battery.

The adhesive material 20 may be any adhesive capable of adhering or sticking two or more objects together. The adhesive 20 may be in the form of a paste, liquid, film, or tape. The adhesive 20 may be made of a synthetic material such as elastomers, thermoplastics, emulsions, or thermosets. In particular embodiments, the adhesive is ii tape such as single-sided or double-sided duct-tape. In other embodiments, the adhesive material 20 is a mechanical adhesive, illustratively including, buttons, snaps, hook and loop fasteners or touch fasteners (VELCRO®), screws, nuts and bolts, clamps, clasps, latches, and equivalents thereof.

With reference to FIGS. 2A-2D, a particular inventive embodiment of an adherable weight scale 10 is shown having an object 30 adhered thereto, where FIGS. 2A and 2C are anterior side views thereof, and FIGS. 2B and 2D are bottom views thereof. The object 30 may include a side surface 32 and a bottom surface 34. The adhesive material 20 may include a top adhesive portion 20a and bottom adhesive portion 20b and may both be formed of a pliable adhesive material (e.g. tape) that can wrap around one or more edges of the object 30. The top adhesive portion 20a may include a bottom section 21a to directly adhere the sensing surface 18 to the bottom surface 34 of the object 30. The top adhesive portion 20a further includes a side section 21b that wraps around a bottom edge of the object 30 to directly adhere a back surface of the display panel 16 to the side surface 32 of the object 30 such that when the object 30 is sitting upright and on-top of the load sensor(s) (12a, 12b), the display panel 16 can be seen by a user. The bottom adhesive portion 20b is then applied over the load sensor(s) (12a, 12b), microcontroller 12, and any other components other than the display panel 16 to surround, conceal, secure, or otherwise cover said components to the object as shown in FIGS. 2C and 2D. The bottom adhesive portion 20b may likewise include a bottom section 23a and side section 23b. A plurality of wires 28 may operatively connect the load sensor(s) (12a, 12b), microcontroller 14, and the display panel 16 together, and may be adhered between the top adhesive portion 20a and bottom adhesive portion 20b.

In a particular inventive embodiment, with reference to FIGS. 3A-4C, in which like reference numerals have the meaning ascribed to that numeral with respect to the aforementioned figures, an adherable weight scale 10 may further include a tray 40. The tray 40 is generally configured to provide a rigid support to the adherable weight scale 10 and to assemble the power source 17 (e.g., a battery) and one or more load sensors (12a, 12b) therewithin. The tray 40 may be made of a polymeric material and may be formed in the shape of a disc. FIG. 3A depicts a front exploded view of the adherable weight scale 10 having a tray 40, FIG. 3B depicts a top view of the assembled weight scale 10, but having the top adhesive portion 20a hidden for visual clarity, and FIG. 3C depicts a bottom view thereof, but having the bottom adhesive portion 20b hidden for visual clarity. FIG. 4A depicts a top perspective view of the tray 40 having components assembled therein, FIG. 4B depicts a bottom perspective view thereof, and FIG. 4C depicts a cross-sectional view thereof. The tray 40 includes a top surface 42 having one or more load sensor recesses (44a, 44b) to receive a load sensor (12a, 12b) therein, a bottom surface 43 having a power source recess 48 for receiving a power source (e.g., a battery) therein, and two or more support beams (46a, 46b) projecting from the bottom surface 43 and running along a length of the tray 40. The tray 40 may further include one or more channels (50a, 50b) for directing wires (not shown) from the power source 17 to at least one of the load sensor(s) (12a, 12b), microcontroller 12, or display panel 16. The tray 40 and components assembled therein are positioned or ‘sandwiched’ between the bottom sections (21a, 23a) of the top adhesive portion 20a and bottom adhesive portion 20b. The top adhesive portion 20a is then adhered to the bottom surface 34 of the object 30 to directly adhere the sensing surface(s) 18 of the load sensor(s) (12a, 12b) to the bottom surface 34 of the object 30. Likewise, the side sections (21b, 23b) of the top adhesive portion 20a and bottom adhesive portion 20b may wrap around a bottom edge of the object 30 to adhere a back surface of the display panel 16 to the side surface 32 of the object 30 as shown in FIGS. 2A-2D.

In a specific inventive embodiment, with reference to FIGS. 5A-5D, in which like reference numerals have the meaning ascribed to that numeral with respect to the aforementioned figures, an adherable weight scale 10 may include a housing assembly 52 having a housing 56 with a compressible weighing platform 54. FIG. 5A is a front view of the adherable weight scale 10 having an object adhered thereto, FIG. 5B is a side view thereof, FIG. 5C is an exploded side view of the adherable weight scale 10, and FIG. 5D is a top perspective view of the assembled housing assembly 52 (note, the weighing platform 54 is hidden in FIG. 5D to show the components assembled in the housing 56). The housing assembly 52 is generally configured to act as a platform for the object 30 and to assemble many of the aforementioned components therein. The housing 56 includes a bottom wall 58, a side wall 60, and a compressible weighing platform 54 opposing the bottom wall. The weighing platform 54 includes a bottom surface 64 and a top surface 62, where the bottom surface 64 engages the sensing surface 18 of the load sensor 12, and the top surface 62 has an adhesive material 20 thereon to indirectly adhere the sensing surface 18 of the load sensor 12 to the bottom surface 34 of the object 30. The weighing platform 54 therefore transfers a load imposed on the top surface 62 to the sensing surface 18 of the load sensor. The housing assembly 52 further includes one or more load sensor(s) (12a, 12b), the microcontroller 14, and power source 17 assembled therein. The housing 56 may include a plurality of structural assembly features (e.g., scaffolding, fixation holes) to assemble those components therein. The housing assembly 52 may further include an instrumentation amplifier 66 and a transceiver 68 assembled in the housing 56. The amplifier 66 and transceiver 68 are in communication with the load sensor(s) (12a, 12b) and/or microcontroller 14. The amplifier 66 may amplify a signal sensed from the load sensor(s) (12a, 12b) and send the amplified signal to the microcontroller 14. In some embodiments, the transceiver 68 is configured to transmit data to/from an external source such as a computer network as further described below.

The adherable weight scale 10 may further include a display panel frame 70 supporting the display panel 16 to permit a user to readily view the display panel 16 on a side of the object. The display panel frame 70 may include a first elongated portion 72, an angular bend 74, and a second elongated portion 76. The first elongated portion 72 is connected to and extends away from the housing 56 in a direction parallel to the weighing platform 54 and terminates at the angular bend 74. The second elongated portion 76 has a first end connected to the angular bend 74 and a second end connected to the display panel 16, where the second elongated portion 76 runs perpendicular to the weighting platform 54 so the display panel 16 is viewable on a side of the object. The housing 56 may include a display panel frame receiving portion 78 (e.g., a hole, or fixation element) for receiving and connecting the display panel frame 70 to the housing 56. Finally, the housing 56 may include a power input 80 (e.g., a female universal bus (USB) input, a female A/C power input, a female ThunderboltTM input) for connecting an external power source to the adherable weight scale 10.

To use the adherable weight scale 10 of the present disclosure, a user adheres the load sensor 12, either directly or indirectly, to a bottom surface 34 of the object 30 via the adhesive material 20. The user may adhere the display panel 16 to a side surface 32 of the object 30 using the adhering methods as described above, or the display panel 16 may include a display panel frame 70 that already supports the display panel 16 on a side of the object 30. The user may switch the unit mode to display the weight in the desired units using one or more input mechanisms 19. With the adherable weight scale 10 adhered to the object 30, the scale 10 may continuously monitor and display the weight of the object 30, even while items are added or removed from the object 30 (e.g., container). The processor 22 may further continuously log and store the weight of the object 30 in memory 26. The processor 22 may monitor and/or log the weight of the object over any given time span the user desires. For example, the user may desire to have the weight monitored and/or logged in real-time (milliseconds), or every second, or every minute, or every hour, or every day, or only when there is a detected weight change as described below with reference to FIG. 6D.

With reference to FIGS. 6A-6D, particular embodiments for using the adherable weight scale 10 are shown diagrammatically. A user may first remove the adherable weight scale 10 from the scale's packaging. At which time, the scale is in an idle state [Block 100], the idle state being the state of the scale 10 prior to adhering an object 30 thereto. Next, the weight scale 10 is activated meaning the user has adhered an object 30 thereto [Block 102]. The activation step also provides a signal to the microcontroller that an object 30 has been adhered. The activation signal may be generated by several mechanisms including: i. a load sensed by the load sensor above a threshold load; ii. a tare function initiated to tare the load of the object; or iii. an activation of a mechanical trigger caused by the adherence of the object to the load sensor (the trigger is described in more detail below). A software module stored in the memory 26 includes executable instructions that when executed by the processor 22 may cause the processor 22 to perform several functions. In one embodiment, the executable instructions when executed by the processor 22 may cause the processor 22 to execute a first protocol when the object is first adhered to the load sensor [Block 104]. The first protocol may be executed in response to the activation signal (i.e., at least one of: i. a load sensed by the load sensor above a threshold load; ii. a tare function initiated to tare the load of the object; or iii. an activation of a mechanical trigger caused by the adherence of the object to the load sensor). The first protocol includes a set of first protocol executable instructions that when executed by the processor 22 causes the processor 22 to continuously monitor the presence of the object 30 on the load sensor 12 and log the sensed loads in the memory 26 as long as the object 30 remains adhered to the scale 10 [Block 108].

To monitor if the object 30 adhered to the weight scale 10 has been tampered with (e.g. removed from the scale), or to monitor if the scale 10 is malfunctioning, the software module may include a further set of executable instructions. The processor 22 may execute a second protocol if the adherable weight scale 10 detects that the object 30 has have been tampered-with, removed from the scale, or the scale 10 is malfunctioning (e.g., power-loss, inconsistent readings, and the like) [Block 106]. The second protocol may be executed in response to at least one of: a. a measured weight that is less than an initial weight of the object [Block 118]; b. a measured weight that is negative if the initial weight of the object was tared to zero [Block 124]; or c. a deactivation of the mechanical trigger caused by a dis-adherence of the object from the load sensor. The second protocol includes a set of second protocol executable instructions that when executed by the processor 22 causes the processor 22 to initiate an alarm to warn the user that the adherable weight scale is malfunctioning, the object has been tampered-with, or the object has been removed from the load sensor. The alarm may be in the form of an audible alarm, a visual alarm, a notification on a peripheral device (e.g., smartphone, tablet, personal computer), and/or a signal sent over a controlled network to a specific end-user. A user may then investigate if the alarm is valid by inspecting the weight scale 10. If the user purposely removed the object 30 from the scale 10 [Block 112], then the user may reset the scale 10 [Block 114] to return the scale 10 to an idle state [Block 100]. Otherwise, the alarm is valid and the user should take appropriate action to remedy the situation [Block 116]. In another embodiment, there may be instances where the load sensor 12 temporarily senses an incorrect load that may trigger the second protocol to issue a false positive alarm. For example, if the object is a container and the user lifts up and rotates the container to dispense a substance therein, the load sensor 12 may briefly read a negative value. During this maneuvering, the load sensor 12 may read several incorrect values until the user places the weight scale 10 back into a static position. So, rather than initiate a false positive alarm, the adherable weight scale 10 may include hardware and/or software with executable instructions to mitigate a false positive alarm to be initiated by the second protocol. In one embodiment, the adherable weight scale 10 includes at least one of an accelerometer or gyroscope in communication with the microcontroller 12. The accelerometer and/or gyroscope may be housed in the housing assembly 56, positioned in a recess in the tray 40, or ‘sandwiched’ between a top adhesive portion 20a and a bottom adhesive portion 20b. The accelerometer and/or gyroscope can then sense whether the weight scale 10 is in motion and therefore prevent the execution of the second protocol during the motion [Block 120]. In another embodiment, the executable instructions of the software module may include a timer function. As soon as the adherable weight scale 10 detects that the object 30 has disadhered (e.g., the sensed weight of the object is negative [Block 124]), the timer function starts a timer. If the amount of time from the timer exceeds a threshold time, then the second protocol is initiated [Block 126]. However, if the adherable weight scale 10 measures an acceptable value (e.g., positive value) prior to exceeding the threshold time, then the second protocol is not executed and the weight scale 10 continues to monitor the weight of the object [Block 108]. The threshold time may be set by the user, for example, 1 second, 5 minutes, 10 minutes, etc. In another inventive embodiment, the executable instructions of the software module may include a variable sensed load function. If the load sensor 12 senses an acceptable weight (e.g., a positive static weight), then the weight scale 10 monitors and logs the weight of the object [Block 108]. If the load sensor 12 spontaneously senses loads that continuously vary (i.e. not static), then the weight scale 10 is likely in motion and the scale 10 will continue to monitor and log the weight of the object [Block 108]. After the variable sensed loads discontinue, if the load sensor 12 senses an acceptable weight (e.g., a positive static weight) then the scale 10 will continue to monitor and log the weight of the object [Block 108]. However, if the load sensor 12 senses an unacceptable weight (e.g. a negative static weight) then the second protocol is initiated [Block 110].

With reference to FIG. 6D, a particular embodiment of a first protocol 104 to record weight measurements of a container having a substance therein is shown. After an container is adhered to the weight scale 10, the first protocol 104 monitors for a change in weight [Block 200] as detected by the load sensor 12. If there is no change in weight, than the first protocol 104 does not write or transmit data to a memory [Block 202]. If a change in weight is detected, then the first protocol 104 may optionally determine if the scale and object are in motion [Block 204]. In one embodiment, the motion is detected by reading accelerometer and/or gyroscope data, while in other embodiments the motion is detected with the variable sensed load function, both of which are described above. If motion is detected, than the first protocol does not write or transmit data to a memory [Block 202]. If there is no motion, than the first protocol 104 determines if there was a positive change in weight [Block 206] to discriminate if a substance was added to the container or dispensed from the container. If the weight change is positive, than the weight of the object is written to memory and/or transmitted over a network, and the weight change may be labeled as a positive weight change [Block 212]. If the change in weight is negative, than the weight of the object is likewise written to memory and/or transmitted over a network and may be labeled as a negative weight change [Block 214]. Subsequently, the first protocol 104 may compute an amount of the substance added or dispensed from the container by adding or subtracting the written positive weight or written negative weight from the previous weight (i.e., the weight of the container prior to the detected weight change) [Block 214]. The amount of the substance added or dispensed is then logged, for example in a inventory management database, and may be time stamped. For example, at 2:15 pm, 5 grams of Substance A was dispensed from its respective container. These entries get logged each time there is a detected weight change. The time stamp may be useful to coincide the dispensing of a substance with an employees work schedule. Finally, a user or a software module may generate reports from the logged data to account for the inventory (e.g., different substances) that has been added or dispensed from one or more containers [Block 218]. It should be appreciated, that in FIG. 6D, not all of the steps are necessarily part of the first protocol 104, where other software modules, programs, or protocols may execute one or more of these steps. For example, the first protocol when executed by the processor may only perform the steps from Block 200 to Block 210 and Block 212, where the first protocol ends by transmitting the measured weights to a secondary program (e.g., a database). The secondary program may then execute the steps from Block 214 to Block 218.

In a particular embodiment, the sensed loads, weight measurements, and any generated alarms may be transmitted over an internal or external network with the transceiver 68. The transceiver 68, such as a wireless transceiver, may transmit at least one of the sensed loads, weight measurements, or alarms across the network to an external database or memory. The database may include inventory management software to manage an inventory of a substance added to or removed from an object, such as a container. The external database may be located at an external location from the adherable weight scale. In some embodiments, the external database is located at an external location that is within the same facility as the adherable weight scale. In other embodiments, the transceiver 68 may further transmit data over an external network to continuously monitor and log the weight of an object from an external location outside of the facility of the adherable weight scale, such as the location of a regulatory agency.

### Internal Network of Adherable Weight Scales

With reference to FIGS. 7A-7E, a particular embodiment of an internal network 81 of adherable weight scales is shown. The internal network 81 is generally configured to monitor the weight of one or more objects within a single location, such as a warehouse. The internal network provides an extra layer of security and keeps all of the weight data in-house with a single node to transfer data externally. The internal network is particularly advantageous for monitoring the weight of an object that is much larger than a single adherable weight scale 10 as shown in FIG. 7E. The internal network 81 generally includes a plurality of adherable weight scales 10, a router 85, and a server 87. Each of the plurality of adherable weight scales 10 adhere to a different region of a bottom surface of an object, therefore expanding the weighable coverage area. The router 85 is generally in communication with the plurality of adherable weight scales 10 to send and receive data to and from the plurality of adherable weight scales 10. The router 85 may further be in communication with a modem and an external network, such as the Internet 83. The server 87 is in communication with the router 85 to receive and store data that is accessible by the plurality of weight scales 10 and/or one or more peripheral devices (e.g., personal computer, tablet, smartphone).

In a particular embodiment, the internal network 81 includes a parent weight scale 10′ in communication with a plurality of child weight scales 10″ and a display unit 84. The parent weight scale 10′, child weight scales 10″, and display unit may each include a transceiver 68, such a wireless transceiver, to wirelessly transfer data to and from each other, the router 85, and/or the server 87. With reference to FIG. 7B, the parent weight scale 10′ includes a housing assembly 56 having a weighing platform 54 with an adhesive material 20 thereon, a display panel 16′, and user input mechanisms 19. The parent weight scale 10′ may further include a set of feet 82. The display panel 16′ of the parent scale 10′ projects directly from a side wall of the housing assembly 56 to be seen below and in front of an object. The display panel 16′ may display data other than weight measurements, illustratively including, object identification number, internet protocol address, wireless connectivity status, as well as provide an interface for user input data. The parent weight scale 10′ may generally act as a central hub to the child weight scales 10″ and the display unit 84 to create an adherable weight scale network that monitors the weight of a larger object. The parent weight scale 10′ may communicate with the router 85, where the parent scale 10′ then transmits the data from the router 85 to the child scales 10″ and display unit 84. The child scales 10″ and display unit 84 may only communicate with the parent scale 10′, where the parent scale 10′ may then transmit data received from the child scales 10″ or display unit 84 to the router 85. The parent weight scale 10′ may further include a parent router or parent wireless access point to improve data transfer in a larger facility. With reference to FIG. 7C, the child scales 10″ include a housing assembly 56 having a weighing platform 54 with an adhesive material 20 thereon. The child scales 10″ may not include a display panel, as the recorded weight measurements for the child scales 10″ are sent directly to the parent scale 10′, which can then send the weight measurements to the router 85 and server 87. With reference to FIG. 7D, the display unit 84 includes a flat top surface 85 to slide underneath an object, a display panel 16, and user input mechanisms 19. The display panel 16 of the display unit 84 displays the weight measurement of the object. The weight measurement may include the sum of the weights recorded by each child scale 10″ and the parent scale 10′, or the user may have the option to filter through and see how much weight a particular scale is measuring. FIG. 7E depicts an arrangement of a parent scale 10′, three child scales (10a″, 10b″, 10c″), and a display unit 84 to continuously monitor the weight of a large tub 86 having an addable and removable substance therein.

In a particular embodiment, the internal network 81 does not include a parent scale 10′, but rather includes just two or more child scales 10″ that directly communicate with the display unit 84 and the router 85. In another embodiment, the internal network 81 does not include child scales 10″, but rather just includes two or more parent scales 10′ that directly communicate with the display unit 84 and the router 85. In a further embodiment, the internal network 81 does not include a display unit 84, but rather all of the data is read and displayed in a database stored on the server 87 and accessible by one or more peripheral devices. It should be appreciated that a multitude of arrangements are possible. It is further contemplated that one or more stand-alone adherable scales 10 adhered to just one object (such as the embodiment shown in FIG. 5A) are present in the internal network 81, with or without parent scales 10′ or child scales″, to transmit and receive data to a router 85 and/or server 87.

The internal network 81 provides a user with the ability to actively monitor the weight of one or more objects through a network, requiring minimal user effort. The network 81 actively monitors and records the weights of the objects to the server 87, which can be accessible by a user on one or more peripheral devices. A user may easily assign an object identifier to one or more of the scales that are adhered to the object, such that the weights are associated with the correct object. The weights may be continuously logged and/or monitored for the lifetime of the product in a database. The database may exist on the server 87 and further include or be an inventory management control software system to manage inventory that may be added or removed from a container adhered to the adherable weight scales 10. At any point, if the object is tampered-with, an alarm may be sent to the database or a peripheral device to warn the user of potential tampering as described above. All of which greatly improves the efficiency and ability to monitor and log the weight of an object, particularly for a regulated substance.

In a specific embodiment, the router 85 is in communication with an external network, such as the Internet 83, where the weight measurements and/or inventory control data may be sent directly to an external location. The external location may be a regulatory agency that can then monitor the inventory remotely without having to perform in-person regulatory audits.

Finally, in a particular embodiment, with reference to FIG. 8, the adherable weight scale 10 may include a mechanical trigger 88 to signal to the microcontroller 12 if the scale is in an active state [Block 102], or if an object has been removed from the scale 10 [Block 106] as described above. The mechanical trigger 88 may be a pressure button that projects normal to the weighing platform 54. An adhesive cover, such as a peelable thin film that covers the adhesive material 20 prior to adhering an object, may cover and press the button down until a user peels off the adhesive cover to expose the adhesive material. A biasing spring may then force the button upwards in a un-pressed state and may signal to the microcontroller 12 that an object is about to be adhered thereto. Once the object presses the button back down, a signal is generated that the object is now adhered. In another embodiment, the mechanical trigger 88 is a pressure sensor that can sense the pressure being applied between the object and the weight scale. The pressure sensor may act in a similar manner as the pressure button, but instead senses for changes in pressure between the object and the scale.

### Other Embodiments

While at least one exemplary embodiment has been presented in the foregoing detail description, it should be appreciated that a vast number of variations exist. It should also be appreciated that the exemplary embodiment or exemplary embodiments are only examples, and are not intended to limit the scope, applicability, or configuration of the described embodiments in any way. It should be understood that various changes may be made in the function and arrangement of elements without departing from the scope as set forth in the appended claims and the legal equivalents thereof.

What is claimed is:

1. An adherable weight scale to continuously monitor the weight of an object when adhered thereto, the adherable weight scale comprising:
a load sensor having a sensing surface;
a microcontroller having a processor, said microcontroller disposed in communication with the load sensor to convert a sensed load into a displayable weight measurement;
a power source connected to at least one of the load sensor and microcontroller to provide power thereto; and
an adhesive material adapted to removably adhere the sensing surface of the load sensor to a bottom surface of an object, either directly or indirectly, wherein the load sensor continuously senses a load of the object when adhered thereto.

2. The adherable weight scale of claim 1 wherein the microcontroller further comprises memory in communication with the processor, and a software module stored in the memory comprising executable instructions that when executed by the processor cause the processor to:
execute a first protocol when the object is first adhered to the load sensor, said first protocol executed in response to at least one of: i. a load sensed by the load sensor above a threshold load; ii. a tare function initiated to tare the load of the object; or iii. an activation of a mechanical trigger caused by the adherence of the object to the load sensor;
wherein said first protocol includes a set of first protocol executable instructions that when executed by the processor cause the processor to continuously monitor the presence of the object on the load sensor and log the sensed loads in the memory.

3. The adherable weight scale of claim 2 wherein the software module stored in the memory further comprises executable instructions that when executed by the processor cause the processor to:
execute a second protocol, said second protocol executed in response to at least one of: (a) a measured weight that is less than an initial weight of the object; (b) a measured weight that is negative if the initial weight of the object was tared to zero; or (c) a deactivation of the mechanical trigger caused by a dis-adherence of the object from the load sensor;
wherein said second protocol includes a set of second protocol executable instructions that when executed by the processor cause the processor to initiate an alarm to warn the user that the adherable weight scale is malfunctioning, the object has been tampered-with, or the object has been removed from the load sensor.

4. The adherable weight scale of claim 3 further comprising:
a transceiver in communication with the processor and a network to transmit at least one of the sensed load, displayable weight measurement, or alarm across the network to at least one of an end-user or an external database, to continuously monitor the weight of the object from an external location away from the adherable weight scale.

5. The adherable weight scale of claim 3 wherein the second protocol is executed only if (a), (b), or (c) have occurred for over a threshold period of time to mitigate a false positive alarm.

6. The adherable weight scale of claim 3 further comprising at least one of an accelerometer or gyroscope disposed in communication with the microcontroller to io detect motion of the adherable weight scale, wherein said second protocol is not executed if the accelerometer or gyroscope detect motion.

7. The adherable weight scale of claim 3 wherein the adhesive material is positioned on the sensing surface to directly adhere the sensing surface to the bottom surface of the object.

8. The adherable weight scale of claim 3 further comprising a display panel in communication with the microcontroller to display the displayable weight measurements, said display panel including a display surface and a back surface opposing the display surface, wherein the adhesive material is positioned on the back surface to directly adhere the display panel to a side surface of the object.

9. The adherable weight scale of claim 3 further comprising:
a first load sensor; and
a second load sensor positioned adjacent to the first load sensor, said first load sensor and second load sensor being adherable to an object, either directly or indirectly, via the adhesive material;
wherein the second load sensor acts as a redundant sensor to either: improve the accuracy of weight measurements by sensing across a larger surface area of the object; or detect if the first load sensor or second load sensor is malfunctioning by evaluating a difference between a sensed load from the first load sensor and a sensed load from the second load sensor.

10. The adherable weight scale of claim 3 further comprising:
a housing assembly, said housing assembly comprising:
a housing for assembling the load sensor and the microcontroller therein, the housing having a bottom wall, a side wall, and a weighing platform opposing the bottom wall, the weighing platform comprising:
a bottom surface engaged with the sensing surface of the load sensor; and
a top surface having the adhesive material thereon to indirectly adhere the sensing surface of the load sensor to the bottom surface of the object;
wherein the weighing platform transfers a load imposed on the top surface to the sensing surface of the load sensor.

11. The adherable weight scale of claim 10 further comprising:
a display panel in communication with the microcontroller to display the displayable weight measurements;
a display panel frame supporting the display panel to permit a user to readily view the display panel on a side of the object, the display panel frame comprising:
a first elongated portion connected to and extending away from the housing in a direction parallel to the weighing platform and terminating at an angular bend; and
a second elongated portion having a first end connected to the angular to bend and a second end connected to the display panel, said second elongated portion running perpendicular to the weighting platform so the display panel is viewable on the side of the object.

12. The adherable weight scale of claim 3 further comprising an object adhered to the sensing surface of the load sensor, directly or indirectly, via the adhesive material.

13. The adherable weight scale of claim 12 wherein the object is a container having a substance disposed therein, wherein the substance is a regulated substance regulated by a regulatory agency, said regulated substance including at least one of marijuana, prescription drugs, tobacco products, alcohol, or currency.

14. The adherable weight scale of claim 3 wherein the adhesive material is in the form of a paste, liquid, film, or tape.

15. An internal network of adherable weight scales to continuously monitor the weight of an object, the internal network comprising:
a plurality of adherable weight scales of claim 3 for adhering to multiple regions of a bottom surface of an object;
a router in communication with the plurality of adherable weight scales to send and receive data to and from the plurality of adherable weight scales; and
a server in communication with the router to receive and store data that is accessible by one or more peripheral devices.

16. The internal network of claim 15 wherein the one or more peripheral devices are a personal computer, a tablet, or a smartphone.

17. The internal network of claim 15 wherein the plurality of adherable weight scales each includes a wireless transceiver to wirelessly transfer data to and from the router.

18. The internal network of claim 17 wherein the plurality of adherable weight scales comprise:
a parent adherable weight scale having at least one of a parent router or a parent wireless access point in communication with the router; and
a plurality of child adherable weight scales in communication with the parent adherable weight scale.

19. The internal network of claim 17 wherein the server includes inventory management control software for managing an inventory of a substance added to or removed from the object.

20. The internal network of claim 19 wherein the router is in communication with an external network to transfer data from the inventory control software to an external location.
